(19) United States
(12) Patent Application Publication
(10) Pub. No.: US 2021/0178486 A1
(43) Pub. Date: Jun. 17, 2021

(54) DEVICE FOR THE MANUFACTURE AND SURFACE PROCESSING OF A THREE-DIMENSIONAL OBJECT

(71) Applicant: O.R. LASERTECHNOLOGIE GMBH, Dieburg (DE)

(72) Inventors: Andreas LOHNER, München (DE); Markus WOLF, Mörfelden-Walldorf (DE)

(73) Assignee: O.R. LASERTECHNOLOGIE GMBH, Dieburg (DE)

(21) Appl. No.: 16/761,485

(22) PCT Filed: Oct. 25, 2018
(86) PCT No.: PCT/EP2018/079313

§ 371 Date: May 4, 2020

(30) Foreign Application Priority Data
Nov. 10, 2017 (DE) 10 2017 010 474.3

(51) Int. Cl. B22F 10/66; B22F 10/20; B22F 12/67; B22F 12/41; B22F 12/50

(52) U.S. Cl. CPC B22F 10/66; B22F 10/20; B33Y 30/00; B22F 12/41; B22F 12/50; B22F 12/67

(57) ABSTRACT

This invention discloses a device 100 for the manufacture of three-dimensional objects by means of the sequential consolidation of layers of pulverized consolidatable build-up material at locations corresponding with the respective cross-section of the object, by means of radiation, in particular laser radiation. The device 100 comprises a processing chamber 200, a first carrying device (300) that is at least partially arranged on or partially inside the processing chamber (200), with a carrier that is adjustable in height for the carrying of the objects and/or the build-up material, an irradiation device (400) for the irradiation of layers of the build-up material at locations corresponding with the respective cross-section of the object, a layer preparation device (500) for the preparation of a layer of the build-up material on the carrier or on the most recently applied and/or irradiated layer, a processing device (600) for the mechanical processing of at least partial areas of the consolidated build-up material, whereby the processing device (600) is designed in such a manner that the mechanical processing of the consolidated build-up material occurs at least partially in the surrounding unconsolidated build-up material. The device is characterized by the fact that the processing device (600) is arranged in an at least partially mobile manner on the layer preparation device (500).

The invention refers to a device for the manufacture of three-dimensional objects by means of the sequential consolidation of layers of pulverized consolidatable build-up material at locations corresponding with the respective cross-section of the object, by means of radiation, in particular laser radiation. The device comprises a processing chamber, a carrying device with a carrier that is adjustable in height for the carrying of the objects and/or the build-up material that is arranged inside the processing chamber, an irradiation device for the irradiation of layers of the build-up material at locations corresponding with the respective cross-section of the object, a layer preparation device for the preparation of a layer of the build-up material on the carrier or on the most recently applied and/or irradiated layer, a processing device for the mechanical processing of at least partial areas of the consolidated build-up material, whereby the processing device is designed in such a way that the mechanical processing of the consolidated build-up material occurs at least partially in the surrounding unconsolidated build-up material.

Over the last few years, manufacturing processes for three-dimensional objects by means of laser radiation, which are also known under the synonyms selective laser melting, selective laser sintering or even selective melting of powder, have found increasingly wider application and attention. The creation of the object is essentially therein based upon the following principle: the three-dimensional object that is to be manufactured is built up according to digital construction data, CAD data in layers from a pulverized build-up material. For this purpose, the construction file is initially deconstructed into layers which are suitable for the manufacturing process and subsequently the build-up material is consolidated or alternatively amalgamated by means of location-selective radiation in accordance with a cross-sectional pattern of the object mapped out according to the respective layers. The deflection of the laser beam thereby occurs by means of a beam deflection device, whereby the control of this beam deflection device occurs in turn by means of a control device on the basis of geometric description data of the object to be manufactured. The laser beam designs the cross-sectional pattern of the object on the most recently prepared layer of build-up material associated with this layer, in order to correspondingly amalgamate the build-up material selectively according to the cross-sectional pattern. Following such a radiation operation, the preparation of the next layer is hereinafter carried out using unconsolidated build-up material on top of the most recently selectively amalgamated layer by means of a layer preparation device. For this purpose, the layer preparation device runs over the surface of the carrier or the last powder layer and uniformly spreads the powder on top of it. To enable a simplified nomenclature, the surface of the carrier, upon which the powder layers are applied and by means of which the objects are created will be referred to as the building surface. A new radiation operation in the manner mentioned here above takes place following the creation of a smooth powder coat. Layer after layer arise through the successive repetition of these operations, whereby the cross-sectional layers of the object that are thus manufactured are amalgamated with one another in such a way that they bond to one another. Various metals can be used as build-up material, such as, for example, steel, stainless steel, aluminum, titanium, gold or tantalum. It is also possible that ceramic material powders or polymers can be employed in this type of manufacturing processes. Furthermore, with the method of selective laser melting, it is possible to manufacture virtually all shapes of objects, whereby it is predestined for the manufacture of highly complicated machine elements, prostheses, pieces of jewelry and the like.

The respective setting of the layer in relation to the source of radiation, or alternatively to the beam deflection device, normally occurs by means of the lowering of a carrier which forms a component of a carrying device, upon which the object is built up in a layer-by-layer manner. In the case of selective laser melting, the radiation of the pulverized build-up material employed usually takes place under a protective gas atmosphere. This protective gas atmosphere serves to suppress oxidation and can, for example, be made up of argon or nitrogen. In so doing, the processing chamber is continually flushed with protective gas, inasmuch as protective gas is admitted on one side of the processing chamber, which is then extracted on the opposite side of the processing chamber housing. The extracted protective gas can then be supplied anew to the processing chamber through a circulatory system.

The source of a device for the manufacture of three-dimensional objects, that is based upon the depicted process of selective laser sintering can be found in the work of Carl Deckard and is known from U.S. Pat. No. 4,863,538 or alternatively U.S. Pat. No. 5,155,324.

These devices do however have the disadvantage that the geometric accuracy and quality of the manufactured objects are dependent on the laser beam diameter, the material used, as well as the preset process parameters. These parameters can however only be varied within a certain process window, in such a way that there are limitations as regards the quality of the surface, in particular of the surface roughness as well as the geometric accuracy. Hypothetical possibilities for improvements to these limitations are however not known from these documents.

For an analysis of the quality of the objects manufactured, there is a method for the manufacture of a three-dimensional component by means of a laser melting process that is known from EP 2 598 313 B1, in which a melting area created by an energy input is recorded by means of a sensor device and from which it is possible to deduce sensor values for the evaluation of the respective construction quality. The method is further characterized by the fact that the sensor values recorded for the evaluation of the construction quality are stored together with the coordinate values that are to be localized in the component and are represented by means of a visualization device in a two and/or multidimensional representation in relation to their recorded location in the component.

A disadvantage of this method is, however, that, notwithstanding it is a possibility for evaluation of the quality of the object, there is however no further information that is given relating to the concrete improvement of the surface quality of the objects.

A concrete invention for the improvement of the geometry of the objects to be manufactured is known from EP 1 439 050 B1. It is possible that one is led to vertical projections of consolidated build-up material during the radiation process due to irregularities in the layer preparation. These projections influence the subsequent layer preparation and thereby also the geometry and the homogeneity of the entire object to be manufactured. As a solution to this problem, a layer preparation device is disclosed in EP 1 439 050 B1, that exhibits a shearing blade, with which these projections are sheared off during the subsequent layer preparation stage and with which the homogeneity and quality of the individual layers of the object are improved.

It is, however, a disadvantage of this invention that layers of the consolidated build-up material can solely be processed in a vertical direction, and thereby solely the thickness of the layer can be processed and not the entire geometry of the object.

A device is known from EP 1 289 736 B2, which exhibits a processing device for the mechanical detail work in essentially vertical surfaces. By means of an additional processing device of this type, it is made possible to completely process the object to be manufactured and thereby to significantly improve its surface quality.

A disadvantage of this invention is, however, that the additional processing tool is laid out as a completely independent mechanical component within the processing chamber. This leads to considerable construction and maintenance complexity paired with contemporaneous increased production costs. Further information as regards concrete embodiments of the mechanical mounting of the processing tool are, however, not forthcoming from EP 1 289 736 B2.

The purpose of the invention is therefore to at least limit the disadvantages of the state of the art and, in particular, to improve the geometric and/or surface quality of the manufactured objects. This purpose is solved with a device for the manufacture of three-dimensional objects by means of the sequential consolidation of layers of pulverized consolidatable build-up material at locations corresponding with the respective cross-section of the object, by means of radiation, in particular laser radiation, comprising: a processing chamber, a carrying device that is arranged inside the processing chamber with a carrier that is adjustable in height for the carrying of the objects and/or the build-up material, an irradiation device for the irradiation of layers of the build-up material at locations corresponding with the respective cross-section of the object, a layer preparation device for the preparation of a layer of the build-up material on the carrier or on the most recently applied and/or irradiated layer, a processing device for the mechanical processing of at least partial areas of the consolidated build-up material, whereby the processing device is designed in such a way that the mechanical processing of the consolidated build-up material takes place at least partially in the surrounding unconsolidated build-up material. The device is further characterized by the fact that the processing device is flexibly arranged on the layer preparation device.

The layer preparation device is flexibly arranged inside the processing chamber for a preparation of the powder layers. In particular, the layer preparation device is flexibly arranged in a plane that is parallel to the surface of the carrier upon which the objects are to be built up on, namely the building surface. As a consequence, the layer preparation device is associated with a drive unit or exhibits such a drive itself.

For a mechanical processing of the object that is to be manufactured or that is manufactured, it is necessary that the processing device is at least partially movable in a plane that is parallel to the building surface. The coordinates of a point or of an object inside a plane can be described by means of two coordinate systems. It is thus that, for example, in a Cartesian coordinate system the location indications are provided by means of the X and Y axes, whereas in a coordinate system with polar coordinates, the position is determined by the distance from a predetermined set point r and the angle α to a set direction. The description of a movement occurs in both coordinate systems by means of two movement components made up from the difference between the respective start and end positions.

In the case in which the processing device is arranged on the layer preparation device, it is then possible, that already one movement component is sufficient to achieve the movement of the processing device by means of movement of the layer preparation device. An additional drive unit for a first movement component of the processing device is thereby not necessary. Lastly, the second movement component is achieved by means of the flexible arrangement of the processing device. The movement of the processing device along the layer preparation device, as well as the movement of the layer preparation device, leads to the achievement of both movement components, so that the processing device is movable in a plane parallel to the building surface.

An arrangement of the processing device of this type hereby allows for a significant reduction of the construction and maintenance complexity with a contemporaneous improved precision of the processing device. The systems can be manufactured more economically, more compactly, as well as requiring less maintenance through the cutting out of at least one drive unit.

An advantageous embodiment of the device is characterized by the fact that the processing device for the mechanical processing of at least partial areas of the consolidated build-up material exhibits a milling device.

Milling devices allow for a precise, efficient and economical machining of the at least partially manufactured object. Furthermore, milling devices have been known as processing tools for decades, with intensive experience with their use.

A likewise advantageous embodiment of the device is characterized by the fact that the processing device exhibits a milling device, whereby the milling device exhibits a milling head and a milling cutter and the milling head is detachably fastened to the milling cutter.

An embodiment of this type allows for a speedy and economical exchange of the milling head. This is in particular necessary in the case of wear to the milling head that occurs or modified milling specifications, such as occurs, for example, with different build-up material.

In a likewise advantageous embodiment, the processing device exhibits a drive unit, whereby the drive unit is arranged on the layer preparation device.

The second movement component can be achieved and carried out in an electrically controlled manner by means of the drive unit. An embodiment of this type brings about the advantage that the processing device can be manufactured as a compact construction unit. The same can subsequently be mounted on to the layer preparation unit without major complexity. Moreover, this embodiment allows for a precise movement of, for example, individual components of the processing device.

A likewise advantageous embodiment is characterized by the fact that the processing device exhibits a milling device and a drive unit, whereby the milling device is flexibly arranged on the layer preparation device by means of the drive unit.

A precise movement of the milling device is made possible by means of an embodiment of this type. The drive unit thereby advantageously allows the movement of the milling device in exclusively one direction of motion. More advantageously, the drive unit is thereby a linear unit.

In a further advantageous embodiment the device is characterized by the fact that the layer preparation device exhibits a blade for the preparation of the layer, that the processing device for the mechanical processing of at least partial areas of the consolidated build-up material exhibits a milling device, and that the milling device is flexibly arranged on an axis parallel to the longitudinal axis of the blade on the layer preparation device.

This embodiment enables an exact movement of the milling device along a parallel axis to the blade. This exact movement specification enables a precise spatial arrangement of the milling device.

A likewise advantageous embodiment of the device is characterized by the fact that the layer preparation device exhibits a blade for the preparation of the layer, that the processing device for the mechanical processing of at least partial areas of the consolidated build-up material exhibits a milling device, and that the milling device is exclusively flexibly arranged on an axis parallel to the longitudinal axis of the blade on the layer preparation device.

An embodiment of this type enables a simplified design of the processing device. The milling device is run above the area to be processed for a processing of the manufactured object that is subsequent to the manufacturing process. Thereinafter, the object together with the surrounding unconsolidated build-up material are run against the milling head. The relative movement between the milling device and the manufactured object on an axis that is parallel to the milling device thereby occurs exclusively through the movement of the object. As a consequence, the milling device is advantageously not adjustable in height.

The layer preparation device is rotationally arranged around a rotation axis in a further advantageous embodiment of the device.

A layer preparation device that is movable around a rotation axis brings about an accelerated preparation of the powder layer on the first carrier and thereby an accelerated manufacturing process. The layer preparation device moves by means of the first carrier and creates a homogeneous powder layer. During the subsequent radiation operation for consolidation of the powder, it is possible for the layer preparation device to rotate onwards without any influence on the manufacturing process, bringing it once again to the starting position for the next layer preparation. Multiple passages over the powder layer, as is required in the state of the art, are eliminated. A completely two-dimensional movement of parts of the processing device is moreover enabled by means of the rotation of the layer preparation device and the flexible arrangement of the processing device on the layer preparation device.

In a likewise advantageous embodiment of the device, the layer preparation device exhibits a rotation unit, whereby the rotation unit is 360° rotationally arranged around a rotation axis.

A rotation unit enables a simple realization of individual components of the layer preparation device. The blade device is preferably arranged on the rotation unit. The 360° rotation enables a continuous manufacturing operation without multiple passages of the layer preparation device over areas of the construction platform between individual radiation operations.

In a further advantageous embodiment the device is characterized by the fact that the layer preparation device exhibits precisely one blade for the preparation of the layer.

The blade is the implement of the layer preparation device that is in direct contact with the pulverized build-up material. It is designed, for example, as a rigid element and with the exception of purposes of adjustment of the manufacturing process, it is inflexibly arranged on the layer preparation device. An embodiment of this type results in the advantage that the complete layer preparation device can be manufactured in a mechanically simple manner, whereby savings can be made in costs and maintenance work. A rigid blade also reduces eventual imprecision during the manufacturing process brought on by an unintentional shift or displacement.

The blade advantageously exhibits a rubber lip or is entirely laid out as such.

A rubber lip results in the advantage that slight unevenness of the manufactured object does not hinder during the layering operations. Furthermore, rubber lips are inexpensive during manufacturing, which is turn reduces maintenance costs.

In an advantageous embodiment, the device exhibits a second carrying device with a carrier that is adjustable in height for the carrying of the build-up material which is arranged inside the processing chamber.

By means of an embodiment of this type, it is made possible that the pulverized build-up material that is required for the manufacturing process can be stored in the second carrying device and thereby, just before the start of manufacturing, it can completely be stored inside the processing chamber. The second carrying device can thereby serve as a reservoir for the build-up material. The movable layer preparation device lastly transports the material from the second to the first carrying device and creates a homogeneous powder coat on the first carrier. This results in a reduction of the danger of possible oxidation of the build-up material. Moreover, the build-up material can be transported in a simple and low-maintenance manner from the reservoir to the first carrying device and readied for the manufacturing process.

A likewise advantageous embodiment of the device is characterized by the fact that the processing chamber exhibits a lower wall with at least two openings and that the pulverized build-up material can be transported in the processing chamber by way of an opening.

An embodiment of this type enables a simple and efficient supply process for the pulverized build-up materials.

Further features and embodiments of the device according to the invention are described in more detail with reference to the hereinafter following figure descriptions.

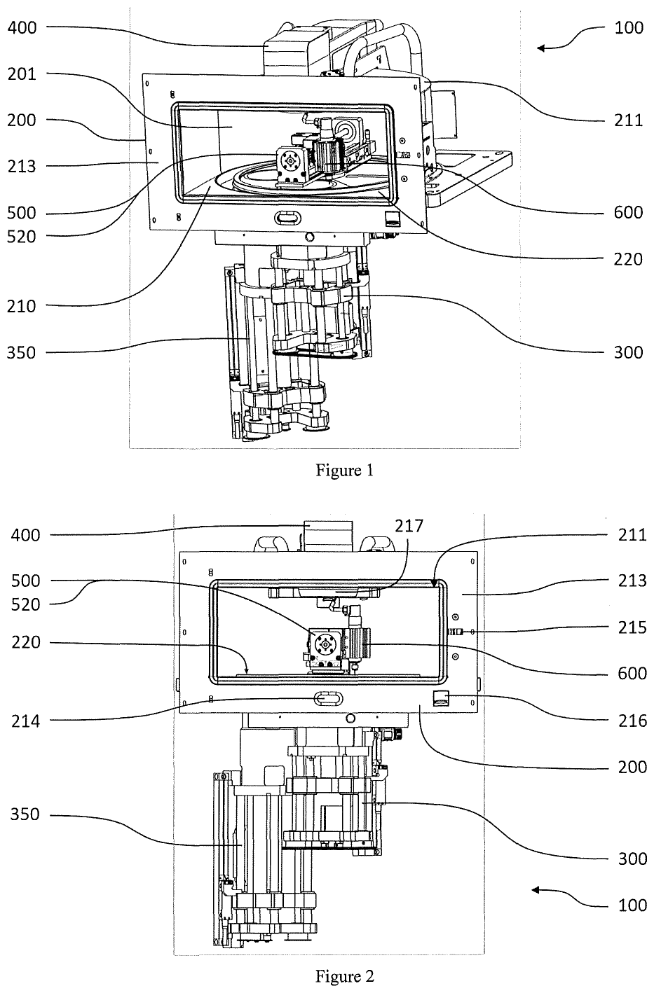

FIG. 1: shows a three-dimensional section representation of a first embodiment of the device,

FIG. 2: shows a section representation of the first embodiment with a perpendicular view on the enclosure wall,

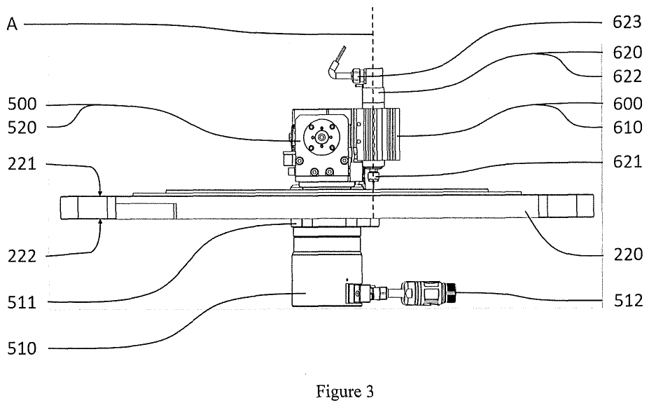

FIG. 3: shows a section representation of the device with a perpendicular view of the front side of the layer preparation device,

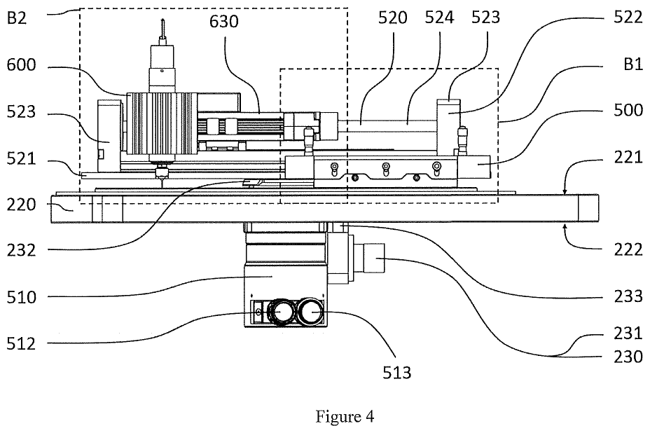

FIG. 4: shows a section representation of the device with a perpendicular view both of the processing device as well as also of the blade device of the layer preparation device,

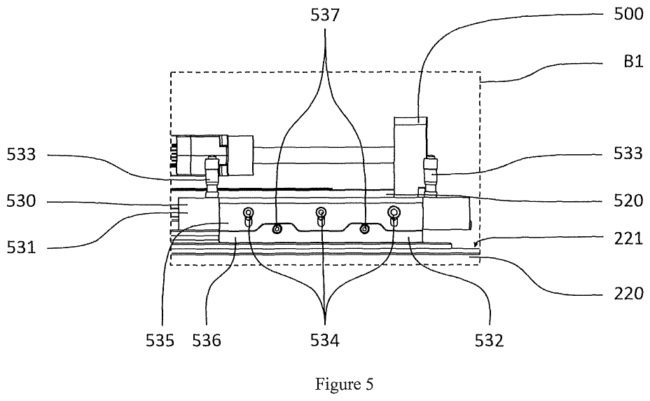

FIG. 5: shows an enlarged representation of the blade device of the layer preparation device,

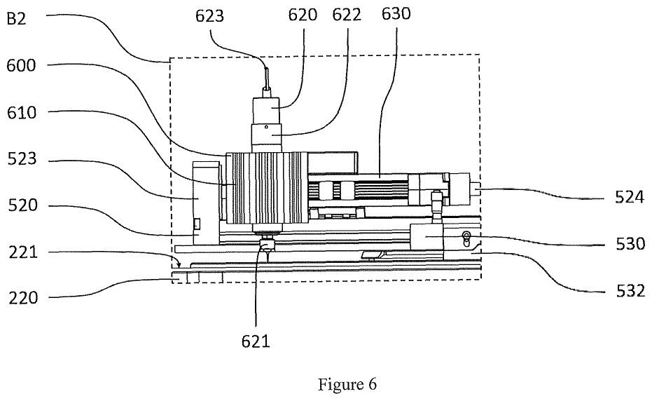

FIG. 6: shows an enlarged representation of the processing device,

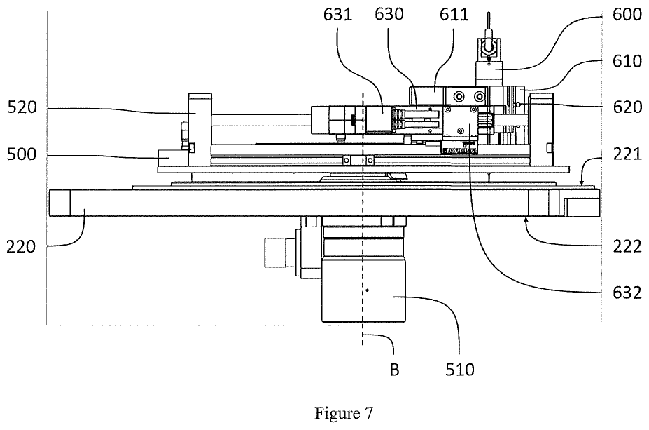

FIG. 7: shows a section representation of the device with a perpendicular view both of the rear side of the processing device as well as also of the back side of the layer preparation device,

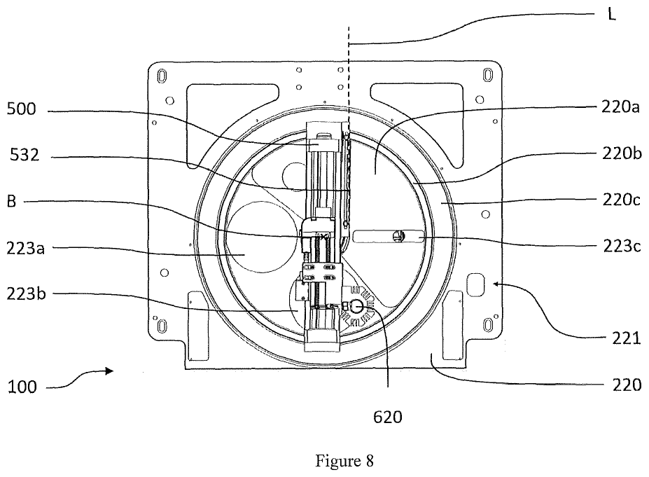

FIG. 8: shows a section representation of the device with a perpendicular view of the inside of the lower wall,

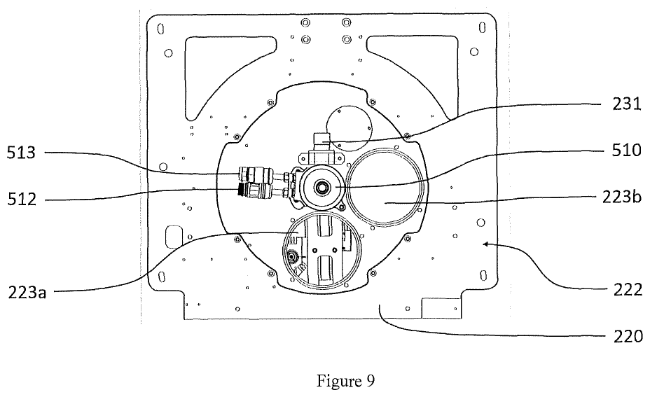

FIG. 9: shows a section representation of the device with a perpendicular view of the outside of the lower wall,

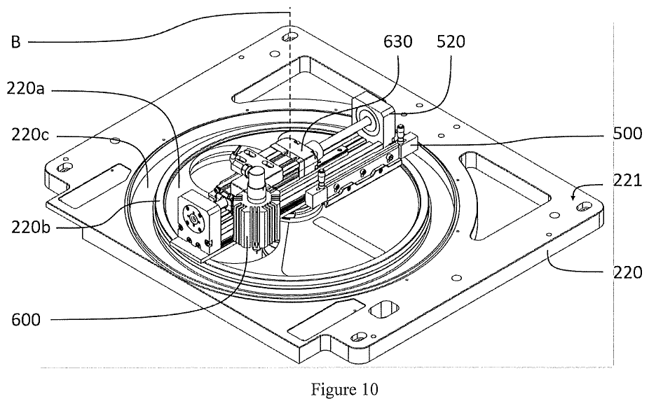

FIG. 10: a three-dimensional sectional representation of the device with a view of the inside of the lower wall.

A three-dimensional representation of an embodiment of the device 100 according to the invention depicted in FIG. 1. The device 100 exhibits a processing chamber 200, a first carrying device 300, a second carrying device 350 as well as an irradiation device 400. The first carrying device 300, as well as the second carrying device 350 and the irradiation device 400, are fastened onto the processing chamber 200 and, in particular, on to the walls 210. The carrying devices 300, 350 are thereby arranged on the lower wall 220 whereas the irradiation device 400 is arranged on the top wall 211. The processing chamber 200 exhibits an access opening 201, by means of which the inside of the processing chamber 200 is, for example, accessible to an operator and through which the supply of pulverized build-up material and/or removal of the manufactured objects takes place. This access opening 201 can be sealed in an airtight manner by means of a door that is not represented in FIG. 1. On top of this, the processing chamber 200 exhibits an enclosure wall 213, in which the door can detachably engage. A layer preparation device 500 and a processing device 600 are found on the inside of the processing chamber 200. The processing device 600 is thereby arranged on the layer preparation device 500. The layer preparation device 500 is arranged on the lower wall 220 of the processing chamber 200. Further features of the layer preparation device 500 and the processing device 600 will be further detailed in conjunction with the hereinafter Figures and their descriptions.

The device 100 from FIG. 1, with a perpendicular view of the enclosure wall 213 is depicted in FIG. 2. It can readily be recognized in this Figure that the enclosure wall 213 exhibits a suction hole 214. This suction hole 214 extends in the area of the lower wall 220 of the processing chamber 200 perpendicular through the enclosure wall 213 and enables a suction of gases and/or smoke particles out of the processing chamber 200. Furthermore, a closing device 215 is arranged on the enclosure wall 213. This closing device 215 enables a detachable fastening of a door that is not depicted in FIG. 2, so that the processing chamber 200 can be sealed in an airtight manner. A security device 216 is also arranged on the enclosure wall 213. The opened or closed status of the door that is not depicted is recorded by means of this security device 216. In this way, it is ensured that the manufacturing process can exclusively take place with a closed door.

It can furthermore be recognized in FIG. 2, that the layer preparation device 500 exhibits a rotation unit 520. The rotation unit 520 is arranged inside the processing chamber 200 and above the lower wall 220. The processing device 600 is laterally arranged on the rotation unit 520.

As already detailed in conjunction with FIG. 1, an irradiation device 400 is arranged on the processing chamber 200. The top wall 211 of the processing chamber 200 exhibits a protective glass 217. This protective glass 217 is arranged below the irradiation device 400 and serves as the optical connection between the irradiation device 400 and the inside of the processing chamber 200.

A section representation of the first embodiment of the device 100 from FIGS. 1 and 2 is depicted in FIG. 3. In this image, it is, in particular, possible to view the lower wall 220, the layer preparation device 500 with the rotation unit 520, as well as the processing device 600. It is also clearly evident that the layer preparation device 500 exhibits a drive unit 510.

As has already been detailed in conjunction with FIGS. 1 and 2, the rotation unit 520 of the layer preparation device 500 is arranged on the lower wall 220 and, in particular, on the inside 221 of the lower wall 220. The inside 221 of the lower wall 220 is thereby the side of the lower wall 220 that is located on the inner side of the processing chamber 200 that is not depicted in FIG. 3. The side of the lower wall 220 that is located outside the processing chamber as a consequence represents the outside 222 of the lower wall 220. The drive unit 510 is arranged on the outside 222. The drive unit 510 and the rotation unit 520 are connected by means of a drive axle that is not represented in FIG. 3. This drive axle extends all the way through the lower wall 220. The layer preparation device 500 is fastened onto the lower wall 220 by means of a lock ring 511. This lock ring 511 is arranged on the outside 222 of the lower wall 220. A connection element 512 is provided on the drive unit 510. The drive unit 510 can be driven and controlled by means of this connection element 512. The drive unit 510 that is represented is an electric motor. The drive unit 510 is preferably a stepper motor.

The processing device 600 exhibits a milling device 620 and a heat sink 610. The milling device 620 exhibits a milling head 621 and a milling cutter 622. The milling device 620 and, in particular, the milling head 621 are thereby the part of the processing device 600, which is moved into the pulverized build-up material and that carry out the actual machining of the manufactured areas of the three-dimensional object that is to be created. On an axis A, that extends perpendicular to the inside 221 of the lower wall 220; the milling device 620 is arranged in an explicitly non-movable manner on the rotation unit 520. The axis A forms the rotation axis of the milling head 621. The milling device 620 exhibits a further connection 623. This connection 623 is preferably an electrical connection that can be used for the supply of power to the milling device 620.

A further representation of the device 100 is depicted in FIG. 4. This section representation corresponds on a technical feature basis to the section representation from FIG. 3, it is however depicted with a 90° rotation. The view therefore falls perpendicularly on the processing device 600. Further features of the layer preparation device 500 and the processing device 600, which are further detailed in conjunction with FIGS. 5 and 6, are, in particular, visible in this representation.

On top of the layer preparation device 500 and the processing device 600, it is visible in FIG. 4 that the device 100 exhibits a gas loop 230. A nozzle 231 pertaining to this gas loop 230 is arranged on the outside 222 of the lower wall 220 of the not depicted processing chamber 200. This nozzle 231 can be used for a connection with suction device that optionally belongs to the device 100 and that is however not depicted in FIG. 4. The nozzle 231 is connected by means of gastight line 233 with an output nozzle 232. The output nozzle 232 is arranged on the inside 221 of the lower wall 220. The line 233 thereby extends all the way through the lower wall 220. A further connection element 513, in addition to the connection element 512 is provided on the drive unit 510 of the layer preparation device 500. This connection element 513 serves to transmit encoder signals and thereby the current position of the layer preparation device 500.

The rotation unit 520 of the layer preparation device 500 is contiguously arranged on the inside 221 of the lower wall 220. The rotation unit 520 exhibits a rotation plate 521 as well as a guiding device 522. The guiding device 522, in turn, exhibits a guide rod 524 as well as two limitation elements 523. The guide rod 524 is arranged between the limitation elements 523. The processing device 600 is arranged on the rotation unit 520.

The processing device 600 exhibits a drive unit 630. The processing device 600 is arranged on the layer preparation device 500 by means of this drive unit 630.

Two areas B1 and B2 are highlighted in FIG. 4 by outlined rectangles. These sections will be further detailed in the following FIGS. 5 and 6 and disclose further features relating to the layer preparation device 500 and the processing device 600.

As has been mentioned here above, the section B1 of FIG. 4 is depicted as an enlargement in FIG. 5. The layer preparation device 500 exhibits a rotation unit 520, that is arranged opposite the inside 221 of the lower wall 220. A blade device 530 is arranged on this rotation unit 520. This blade device 530 exhibits a blade holder 531, a blade 532 as well as two micrometer screws 533. The blade 532 is detachably fastened on the blade holder 531. The blade 532 is moreover movably arranged by means of the micrometer screws 533. The distance between the inside 221 of the lower wall 220 and the blade 532 is adjustable by means of the micrometer screws 533. The blade 532 is detachably fastened to the blade holder by means of three fastening elements 534. The blade 532 is built up out of two parts and exhibits a blade body 535 and a blade edge 536. In so doing, the blade edge 536 is detachably fastened to the blade body 535 by means of fastening elements 537.

Section B2 of FIG. 4 is depicted as an enlargement in FIG. 6. The processing device 600 is arranged on the rotation unit 520. The processing device 600 exhibits a drive device 630. The drive device 630 is arranged on the rotation unit 520. The drive device 630 is, in particular, arranged on the guide rod 524 of the rotation unit 520. The milling device 620 is movable on an axis parallel to the guide rod 524 by means of the drive device 530. The drive device 630 is a linear unit in the embodiment depicted in FIG. 6. The drive device 630 exhibits a spatially limited travel. The milling device 620 is thus flexibly arranged between a limitation element 523 and the blade holder 531 by means of the drive device 630. The heat sink 610 is fastened on the drive device 630.

The milling device 620 exhibits a connection 623. The milling device 620 can be powered by means of the connection 623. The contact of the milling device 620 with the device 100 occurs by means of the top wall 211 of the processing chamber 200 that is not depicted in FIG. 6. Furthermore, the distance between the inside 221 of the lower wall 220 and the milling head 621 is equal to or greater than the distance between the inside 221 of the lower wall 220 and the blade 532 of the blade device 530 of the layer preparation device 500.

FIG. 7 shows the section of the device 100 with a view of the back side of the layer preparation device 500 and the processing device 600. The processing device 600 and, in particular, its heat sink 610 exhibits a connecting element 611. The heat sink 610 is fastened on the layer preparation device 500 by means of the connecting element 611. The processing device 600 furthermore exhibits an encoder 631, by means of which a determination of the current position of the milling device 620 is made possible. The drive device 630 exhibits a motor 632 for the purpose of moving of the milling device 620.

The rotation unit 520 is rotatable around the axis B by means of the drive unit 510 of the layer preparation device 500. The rotation unit 520 is, in particular, 360° rotatable around the axis B by means of the drive unit 510.

A further section of the device 100 is depicted in FIG. 8, with a perpendicular view of the inside 221 of the lower wall 220. The lower wall 220 exhibits three openings 223a, 223b and 223c. These openings 223a, 223b and 223c are arranged around the rotation axis B. The layer preparation device 500 is laid out in such a way that the same can transport the pulverized build-up material from the opening 223a to the opening 223b and further to the opening 223c. The rotation axis B extends perpendicular all the way through the image plane and characterizes the rotation axis of the layer preparation device 500. The lower wall 220 exhibits three different areas 220a, 220b and 220c on its inside 221. In so doing, the area 220a represents the process area 220a, the area 220b the limitation area 220b and 220c the starting area 220c. The process area 220a is the area that is closest to the blade edge 536 (not visible in FIG. 7). The three openings 223a, 223b and 223c are arranged within the process areas 220a. The limitation area 220b, when compared to the process area 220a, is executed at a higher level, in such a manner that, when viewed from the image plane, it is in front of the process area 220a. The starting area 220c is executed at a lower level when compared to the process area 220a, in such a manner that, when viewed from the image plane, it is behind the process area 220a. The limitation area 220b is executed in such a manner it contains the pulverized build-up material within the process areas 220a. The starting area 220c serves to capture the build-up materials, in the event in which it was to nonetheless escape from the process area 220a.

The longitudinal axis L of the blade 532 is likewise visible in FIG. 8. The milling device 620 is movably arranged on an axis parallel to the longitudinal axis L.

A section of device 100 with a perpendicular view on the outside 222 of the lower wall 220 is depicted in FIG. 9. The openings 223a and 223b, which extend all the way through the lower wall 220 are clearly visible. The drive unit 510 of the layer preparation device 500, as well as its connections 512 and 513 are likewise visible.

A three-dimensional section representation of the device 100 is depicted in FIG. 10. The three areas, process area 220a, limitation area 220b and starting area 220c, are clearly recognizable. The same are extensively arranged around the rotation axis B. The processing device 600 is arranged on the layer preparation device 500. The drive device 630 of the processing device 600 serves as the connecting element between the processing device 600 and the layer preparation device 500. The layer preparation device 500 is rotationally mounted around the rotation axis B. The blade device 530 is arranged opposite the processing device 600 on the rotation unit 520.

### REFERENCE SIGN LIST

100 Device
200 Processing chamber
201 Access opening
210 Processing chamber wall
211 Top wall
212 Side wall
213 Enclosure wall
214 Suction opening
215 Closing device
216 Security device
217 Protective glass
220 Lower wall
220a Process area
220b Limitation area
220c Starting area
221 Inside
222 Outside
223a Opening
223b Opening
223c Opening
230 Gas loop
231 Nozzle
232 Output nozzle
233 Line
300 First carrying device
350 Second carrying device
400 Irradiation device
500 Coating preparation device
510 Drive unit
511 Lock ring
512 Connection
513 Connection
520 Rotation unit
521 Rotation plate
522 Guiding device
523 Limitation element
524 Guide rod
530 Blade device
531 Blade holder
532 Blade
533 Micrometer screw
534 Fastening element
535 Blade body
536 Blade edge
537 Fastening element
600 Processing device
610 Heat sink
611 Connecting element
620 Milling device
621 Milling head
622 Milling cutter
623 Connection
630 Drive device
631 Encoder
632 Motor
B1 Section
B2 Section
A Rotation axis
B Rotation axis

1. A device (100) for the manufacture of three-dimensional objects by means of the sequential consolidation of layers of pulverized consolidatable build-up material at locations corresponding with the respective cross-section of the object, by means of radiation, in particular laser radiation, comprising:
a processing chamber (200),
a first carrying device (300) that is at least partially arranged on or partially inside the processing chamber (200), with a carrier that is adjustable in height for the carrying of the objects and/or the build-up material,
an irradiation device (400) for the irradiation of layers of the build-up material at locations corresponding with the respective cross-section of the object,
a layer preparation device (500) for the preparation of a layer of the build-up material on the carrier or on the most recently applied and/or irradiated layer,
a processing device (600) for the mechanical processing of at least partial areas of the consolidated build-up material, whereby the processing device (600) is designed in such a manner that the mechanical processing of the consolidated build-up material occurs at least partially in the surrounding unconsolidated build-up material wherein the processing device (600) is arranged in an at least partially mobile manner on the layer preparation device (500).

2. The device of claim 1 wherein the processing device (600) includes a milling device (620) for the mechanical processing of at least partial areas of the consolidated build-up material.

3. The device of claim 1 wherein the processing device (600) includes a drive device (630) and the drive device (630) is arranged on the layer preparation device (500).

4. The device of claim 1 wherein the processing device (600) includes a milling device (620) and a drive device (630), whereby the milling device (620) is flexibly arranged on the layer preparation device (500) by means of the drive device (630).

5. The device of claim 1 wherein the layer preparation device (500) includes a blade (532) for the preparation of the layer, that the processing device (600) for the mechanical processing of at least partial areas of the consolidated build-up material includes a milling device (620), and that the milling device (620) is flexibly arranged on the layer preparation device (500) on an axis L that is parallel to the longitudinal axis of the blade (532).

6. The device of claim 1 wherein the layer preparation device (500) includes a blade (532) for the preparation of the layer, that the processing device (600) for the mechanical processing of at least partial areas of the consolidated build-up material includes a milling device (620) and that the milling device (620) is exclusively flexibly arranged on the layer preparation device (500) on an axis that is parallel to the longitudinal axis L of the blade (532).

7. The device of claim 1 wherein the layer preparation device (500) includes a rotation unit (520) and the rotation unit (520) is rotationally arranged around a rotation axis B.

8. The device of claim 1 wherein the layer preparation device (500) includes precisely one blade (532) for the preparation of the layer.

9. The device of claim 1 further including one second carrying device (350) with a carrier that is adjustable in height for the carrying of the build-up material arranged inside the processing chamber (200).

10. The device of claim 1 wherein the processing chamber (200) includes a lower wall (220) with at least two openings (223a, 223b) and wherein the pulverized build-up material can be transported in the processing chamber (200) by means of an opening (223a).
